(19) United States
(12) Patent Application Publication
(10) Pub. No.: US 2026/0240332 A1
(43) Pub. Date: Aug. 20, 2026

(54) CONNECTING MEMBER FOR BED FRAME AND BED FRAME

(71) Applicant: ZINUS INC., Seongnam-si, Gyeonggi-do (KR)

(72) Inventors: Youngdo JUNG, Seongnam-si (KR); Doohwan CHA, Seongnam-si (KR)

(21) Appl. No.: 18/876,778

(22) PCT Filed: Jun. 20, 2023
(86) PCT No.: PCT/CN2023/101347

§ 371 Date: Dec. 19, 2024

(30) Foreign Application Priority Data
Jun. 22, 2022 (CN) 202221578152.6

(51) Int. Cl. A47C 19/02; F16B 12/44; F16B 12/46

(52) U.S. Cl. CPC A47C 19/021; F16B 12/46; F16B 2012/446

(57) ABSTRACT

A connecting member for a bed frame includes a longitudinal connecting portion, a lateral connecting portion and a supporting portion. The longitudinal connecting portion is arranged at an end of the supporting part. The longitudinal connecting portion is provided with a first longitudinal mounting hole in which a first longitudinal bar is to be assembled, and a second longitudinal mounting hole in which a second longitudinal bar is to be assembled. The first longitudinal mounting hole is coaxial with the second longitudinal mounting hole and arranged opposite to the second longitudinal mounting hole. The lateral connecting portion intersects with the longitudinal connecting portion, and the lateral connecting portion is provided with a lateral mounting hole in which a lateral bar is to be assembled.

### CROSS-REFERENCE TO RELATED APPLICATIONS

This is a national stage of International Application No. PCT/CN2023/101347, filed on Jun. 20, 2023, which claims priority to Chinese Patent Application No. 202221578152.6, filed on Jun. 22, 2022. The disclosures of International Application No. PCT/CN2023/101347 and Chinese Patent Application No. 202221578152.6 are hereby incorporated by reference in their entireties.

### TECHNICAL FIELD

The disclosure relates to the technical field of furniture assembly, and in particular to a connecting member for a bed frame, and a bed frame.

### BACKGROUND

A bed frame is generally formed by a lateral bar and a longitudinal bar connected to each other. In order to make a width of the bed frame adjustable, in the related art, an adjustable structure for the lateral bar includes the following operations. Firstly, the width of the bed frame is adjusted by lateral bars engaged with each other and slidable relative to each other. The lateral bars are fixed to each other by a locking member after the width is adjusted. The lateral bars engaged with each other need to have different dimensions, which affects the strength of the connection at a junction of the lateral bars. Secondly, the lateral bars are slidably connected to each other by a connecting member. Specifically, each of adjacent lateral bars is provided with a supporting frame in a lateral extension thereof, and is slidably engaged in a respective one of the supporting frames to realize the sliding connection. However, since the adjustable structure has no limit for levels of different dimensions, and it is not intuitive for consumers to adjust the width and the consumers may not quickly adjust the width to the required width.

Moreover, in order to reduce a packaging dimension, the longitudinal bar is usually provided as a sectional type. The longitudinal bar may be collapsed or disassembled into a plurality of sections. When the longitudinal bar is packaged after it is collapsed, the longitudinal bar may not be freely placed, and the packaging dimension may not be minimized. When the longitudinal bar is disassembled into the plurality of sections, the plurality of sections need to be connected to each other by a bolt when they are fixed. In this way, there are many assembly operations and the assembly is troublesome.

### SUMMARY

The disclosure aims to solve at least one of the technical problems in the related art to a certain extent. To this end, an object of the disclosure is to provide a connecting member for a bed frame. When the connecting member for the bed frame is connected to a longitudinal bar of the bed frame, the longitudinal bar may be disassembled into a plurality of sections. When the longitudinal bar is packaged, a packaging volume is small and the packaging is convenient. Moreover, the assembly and the disassembly are more convenient.

A second object of the disclosure is to provide a bed frame.

order to achieve the above objects, embodiments of a first aspect of the disclosure provide a connecting member for a bed frame, which includes a longitudinal connecting portion, a lateral connecting portion and a supporting portion. The longitudinal connecting portion is arranged at an end of the supporting portion. The longitudinal connecting portion is provided with a first longitudinal mounting hole in which a first longitudinal bar is to be assembled, and a second longitudinal mounting hole in which a second longitudinal bar is to be assembled. The first longitudinal mounting hole is coaxial with the second longitudinal mounting hole and arranged opposite to the second longitudinal mounting hole. The lateral connecting portion intersects with the longitudinal connecting portion, and the lateral connecting portion is provided with a lateral mounting hole in which a lateral bar is to be assembled.

In the connecting member for the bed frame according to the embodiments of the disclosure, when the connecting member for the bed frame is connected to the bed frame, the first longitudinal bar of the bed frame is snapped into the first longitudinal mounting hole, and the second longitudinal bar of the bed frame is snapped into the second longitudinal mounting hole. The first longitudinal bar is connected to the second longitudinal bar to form a longitudinal bar of the bed frame. The lateral bar is snapped into the lateral mounting hole, and the lateral bar is connected to the longitudinal bar to form the bed frame. The supporting portion serves as a supporting leg of the bed frame. Therefore, when the connecting member for the bed frame of the disclosure is connected to the longitudinal bar, the longitudinal bar may be disassembled into a plurality of sections. When the longitudinal bar is packaged, a packaging volume is small and the packaging is convenient. Moreover, the assembly and the disassembly are more convenient.

In addition, the connecting member for the bed frame according to the embodiments of the disclosure described above may also have the following additional technical features.

Optionally, each of a side wall of the first longitudinal mounting hole, a side wall of the second longitudinal mounting hole, and a side wall of the lateral mounting hole is provided with a pin hole.

Optionally, the first longitudinal mounting hole and the second longitudinal mounting hole are in communication with each other.

Optionally, the longitudinal connecting portion, the lateral connecting portion and the supporting portion are integrally formed.

Specifically, each of the longitudinal connecting portion, the lateral connecting portion and the supporting portion is a plastic member, and the longitudinal connecting portion, the lateral connecting portion and the supporting portion are integrally injection-molded.

Optionally, the longitudinal connecting portion is provided with a blocking sheet in an extension of the longitudinal connecting portion, and the blocking sheet is arranged opposite to the supporting portion.

Specifically, the blocking sheet is integrally injection-molded with the longitudinal connecting portion.

In order to achieve the above objects, embodiments of a second aspect of the disclosure provide a bed frame, which includes a connecting member for the bed frame, a lateral bar and a longitudinal bar. The connecting member for the bed frame includes a longitudinal connecting portion, a lateral connecting portion and a supporting portion. The longitudinal connecting portion is arranged at an end of the supporting portion. The longitudinal connecting portion is provided with a first longitudinal mounting hole in which a first longitudinal bar is to be assembled, and a second longitudinal mounting hole in which a second longitudinal bar is to be assembled. The first longitudinal mounting hole is coaxial with the second longitudinal mounting hole and arranged opposite to the second longitudinal mounting hole. The lateral connecting portion intersects with the longitudinal connecting portion, and the lateral connecting portion is provided with a lateral mounting hole in which a lateral bar is to be assembled. The longitudinal bar includes a first longitudinal bar and a second longitudinal bar. The first longitudinal bar is snapped into the first longitudinal mounting hole, the second longitudinal bar is snapped into the second longitudinal mounting hole, and the lateral bar is snapped into the lateral mounting hole.

In the bed frame according to the embodiments of the disclosure, the bed frame includes the connecting member for the bed frame. The first longitudinal bar of the bed frame is snapped into the first longitudinal mounting hole, and the second longitudinal bar of the bed frame is snapped into the second longitudinal mounting hole. The first longitudinal bar is connected to the second longitudinal bar to form the longitudinal bar of the bed frame. The lateral bar is snapped into the lateral mounting hole, and the lateral bar is connected to the longitudinal bar to form the bed frame. The supporting portion serves as a supporting leg of the bed frame. Therefore, in the disclosure, the longitudinal bar may be disassembled into a plurality of sections. When the longitudinal bar is packaged, a packaging volume is small and the packaging is convenient. Moreover, the assembly and the disassembly are more convenient.

In addition, the bed frame according to the embodiments of the disclosure described above may also have the following additional technical features.

Optionally, the bed frame includes a plurality of elastic pins each arranged on a respective one of the first longitudinal bar, the second longitudinal bar and the lateral bar. Each of the plurality of elastic pins is snapped into a respective one of a pin hole of the first longitudinal mounting hole, a pin hole of the second longitudinal mounting hole, and a pin hole of the lateral mounting hole.

Specifically, each of the plurality of elastic pins includes an elastic sheet arranged in the respective one of the first longitudinal bar, the second longitudinal bar and the lateral bar, and a pin pillar extending beyond the respective one of the first longitudinal bar, the second longitudinal bar and the lateral bar. The pin pillar is arranged on the elastic sheet.

### BRIEF DESCRIPTION OF THE DRAWINGS

FIG. 1 is a schematic diagram of a connecting member for a bed frame according to an embodiment of the disclosure.

FIG. 2 is a schematic assembly diagram of a connecting member for a bed frame according to an embodiment of the disclosure.

FIG. 3 is a cross-sectional view of a connecting member for a bed frame according to an embodiment of the disclosure.

FIG. 4 is a schematic diagram of a bed frame provided with a connecting member for a bed frame according to an embodiment of the disclosure.

List of reference symbols: connecting member for bed frame 10, longitudinal connecting portion 1, first longitudinal mounting hole 11, second longitudinal mounting hole 12, lateral connecting portion 2, lateral mounting hole 21, supporting portion 3, longitudinal bar 4, first longitudinal bar 41, second longitudinal bar 42, lateral bar 5, pin hole 6, blocking sheet 7, elastic pin 8, elastic sheet 81, and pin pillar 82.

### DETAILED DESCRIPTION

Embodiments of the disclosure are described in detail below, examples of the embodiments are shown in the drawings. Herein, the same or similar reference symbols refer to the same or similar elements or elements with the same or similar functions throughout the description. The embodiments described below with reference to the drawings are exemplary and are intended to explain the disclosure, but cannot be understood as limiting the disclosure.

The disclosure discloses a connecting member for a bed frame. When the connecting member for the bed frame is connected to the bed frame, a first longitudinal bar of the bed frame is snapped into a first longitudinal mounting hole, and a second longitudinal bar of the bed frame is snapped into a second longitudinal mounting hole. The first longitudinal bar is connected to the second longitudinal bar to form a longitudinal bar of the bed frame. A lateral bar is snapped into a lateral mounting hole, and the lateral bar is connected to the longitudinal bar to form the bed frame. A supporting portion serves as a supporting leg of the bed frame. Therefore, when the connecting member for the bed frame of the disclosure is connected to the longitudinal bar, the longitudinal bar may be disassembled into a plurality of sections. When the longitudinal bar is packaged, a packaging volume is small and the packaging is convenient. Moreover, the assembly and the disassembly are more convenient.

In order to better understand the technical solutions described above, exemplary embodiments of the disclosure are described in more detail below with reference to the drawings. Although the drawings illustrate the exemplary embodiments of the disclosure, it should be understood that the disclosure may be implemented in various forms, and should not be limited by the embodiments described herein. On the contrary, the purpose of providing these embodiments is to more thoroughly understand the disclosure, and to fully convey the scope of the disclosure to those skilled in the art.

In order to better understand the technical solutions described above, the technical solutions described above will be described in detail below in combination with the drawings and the detailed description.

### First embodiment

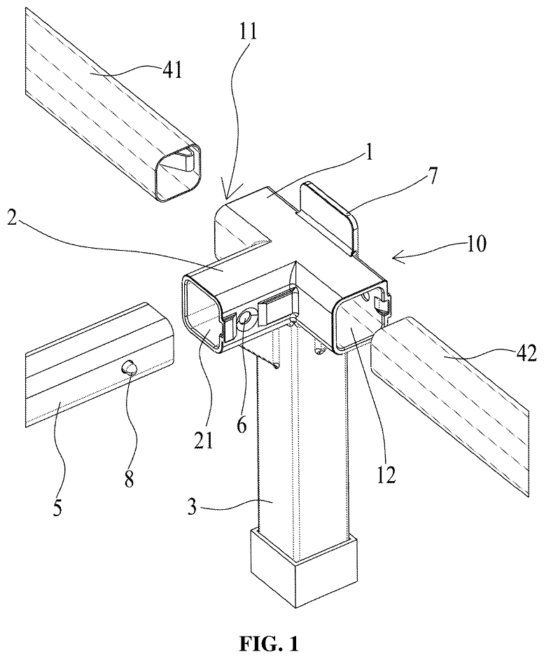

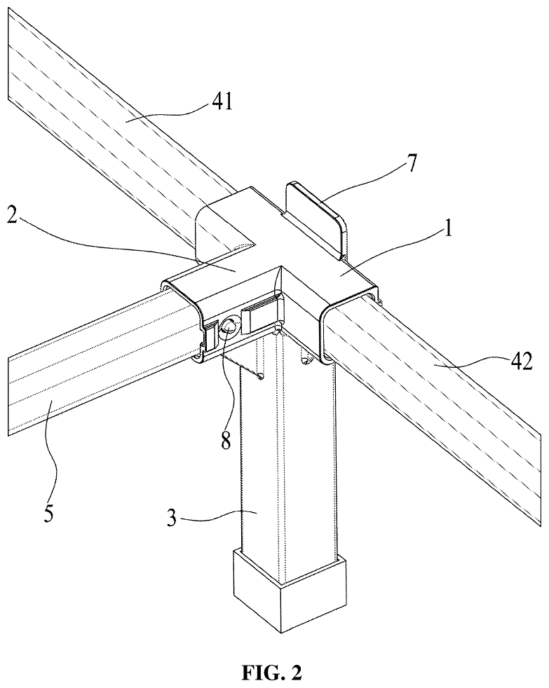

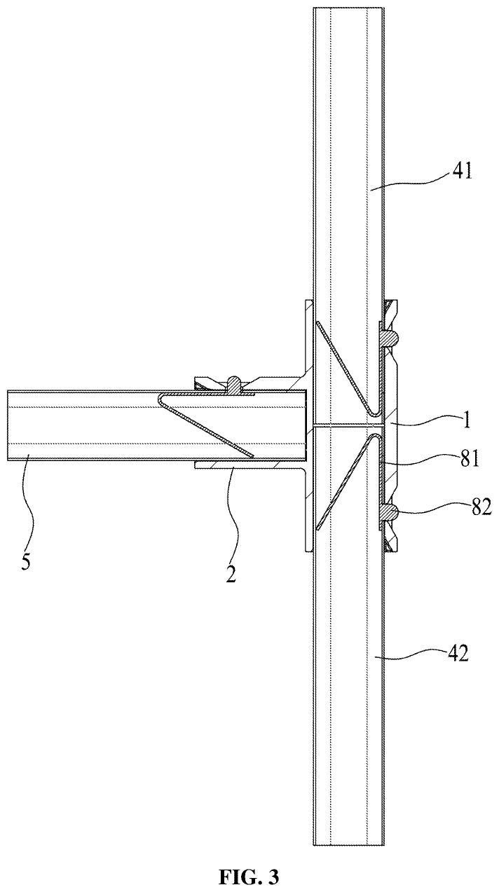

As shown in FIG. 1 to FIG. 4, a connecting member 10 for a bed frame according to embodiments of the disclosure includes a longitudinal connecting portion 1, a lateral connecting portion 2 and a supporting portion 3.

The longitudinal connecting portion 1 is arranged at an end of the supporting portion 3. The longitudinal connecting portion 1 is provided with a first longitudinal mounting hole 11 in which a first longitudinal bar 41 is to be assembled, and a second longitudinal mounting hole 12 in which a second longitudinal bar 42 is to be assembled. The first longitudinal mounting hole 11 is coaxial with the second longitudinal mounting hole 12 and arranged opposite to the second longitudinal mounting hole 12. The lateral connecting portion 2 intersects with the longitudinal connecting portion 1, and the lateral connecting portion 2 is provided with a lateral mounting hole 21 in which a lateral bar 5 is to be assembled.

When the connecting member for the bed frame of the disclosure is connected to the bed frame, the first longitudinal bar 41 of the bed frame is snapped into the first longitudinal mounting hole 11, and the second longitudinal bar 42 of the bed frame is snapped into the second longitudinal mounting hole 12. The first longitudinal bar 41 is connected to the second longitudinal bar 42 to form a longitudinal bar 4 of the bed frame. The lateral bar 5 is snapped into the lateral mounting hole 21, and the lateral bar 5 is connected to the longitudinal bar 4 to form the bed frame. The supporting portion 3 serves as a supporting leg of the bed frame. Therefore, when the connecting member 10 for the bed frame of the disclosure is connected to the longitudinal bar 4, the longitudinal bar 4 may be disassembled into a plurality of sections. When the longitudinal bar 4 is packaged, a packaging volume is small and the packaging is convenient. Moreover, the assembly and the disassembly are more convenient.

Optionally, each of a side wall of the first longitudinal mounting hole 11, a side wall of the second longitudinal mounting hole 12, and a side wall of the lateral mounting hole 21 is provided with a pin hole 6. Each of the pin hole 6 of the first longitudinal mounting hole 11, the pin hole 6 of the second longitudinal mounting hole 12, and the pin hole 6 of the lateral mounting hole 21 is configured to be connected to a respective one of an elastic pin arranged on the first longitudinal bar 41, an elastic pin arranged on the second longitudinal bar 42, and an elastic pin arranged on the lateral bar 5, to allow the assembly and disassembly of the first longitudinal bar 41, the second longitudinal bar 42 and the lateral bar 5 to be convenient.

The first longitudinal mounting hole 11 and the second longitudinal mounting hole 12 are in communication with each other, to allow the injection molding of the first longitudinal mounting hole 11 and the second longitudinal mounting hole 12 to be more convenient. Certainly, the first longitudinal mounting hole 11 and the second longitudinal mounting hole 12 may also be arranged to be independent of each other.

The longitudinal connecting portion 1, the lateral connecting portion 2 and the supporting portion 3 are integrally formed. Specifically, each of the longitudinal connecting portion 1, the lateral connecting portion 2 and the supporting portion 3 is a plastic member, and the longitudinal connecting portion 1, the lateral connecting portion 2 and the supporting portion 3 are integrally injection-molded.

Optionally, the longitudinal connecting portion 1 is provided with a blocking sheet 7 in an extension of the longitudinal connecting portion 1, and the blocking sheet 7 is arranged opposite to the supporting portion 3. Specifically, the blocking sheet 7 is integrally injection-molded with the longitudinal connecting portion 1, and the blocking sheet 7 is arranged on an edge of the longitudinal connecting portion 1. The blocking sheet 7 is configured to prevent a mechanism arranged on the bed frame, such as a mattress, from being displaced, to enable one component to have a plurality of functions.

### Second embodiment

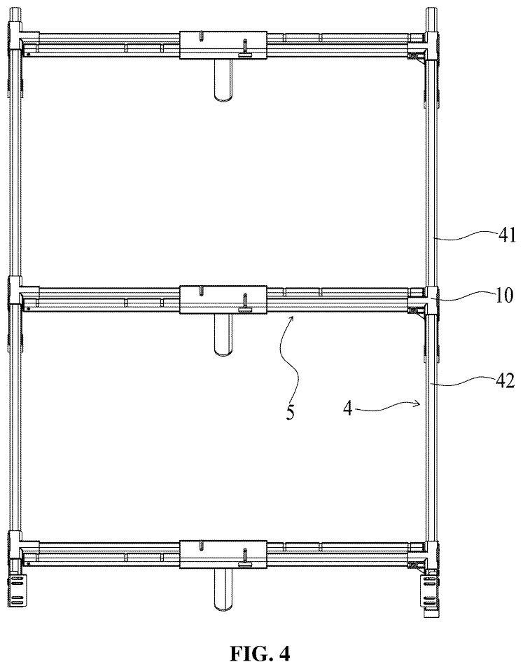

As shown in FIG. 4 and with reference to FIG. 1 to FIG. 3, a bed frame according to embodiments of the disclosure includes a connecting member 10 for the bed frame, a longitudinal bar 4 and a lateral bar 5. The connecting member 10 for the bed frame includes a longitudinal connecting portion 1, a lateral connecting portion 2 and a supporting portion 3. The longitudinal bar 4 includes a first longitudinal bar 41 and a second longitudinal bar 42.

The longitudinal connecting portion 1 is arranged at an end of the supporting portion 3. The longitudinal connecting portion 1 is provided with a first longitudinal mounting hole 11 in which the first longitudinal bar 41 is to be assembled, and a second longitudinal mounting hole 12 in which the second longitudinal bar 42 is to be assembled. The first longitudinal mounting hole 11 is coaxial with the second longitudinal mounting hole 12 and arranged opposite to the second longitudinal mounting hole 12. The lateral connecting portion 2 intersects with the longitudinal connecting portion 1, and the lateral connecting portion 2 is provided with a lateral mounting hole 21 in which the lateral bar 5 is to be assembled. The first longitudinal bar 41 is snapped into the first longitudinal mounting hole 11, the second longitudinal bar 42 is snapped into the second longitudinal mounting hole 12, and the lateral bar 5 is snapped into the lateral mounting hole 21.

The bed frame according to the embodiments of the disclosure includes the connecting member 10 for the bed frame. The first longitudinal bar 41 of the bed frame is snapped into the first longitudinal mounting hole 11, and the second longitudinal bar 42 of the bed frame is snapped into the second longitudinal mounting hole 12. The first longitudinal bar 41 is connected to the second longitudinal bar 42 to form the longitudinal bar 4 of the bed frame. The lateral bar 5 is snapped into the lateral mounting hole 21, and the lateral bar 5 is connected to the longitudinal bar 4 to form the bed frame. The supporting portion 3 serves as a supporting leg of the bed frame. Therefore, in the disclosure, the longitudinal bar 4 may be disassembled into a plurality of sections. When the longitudinal bar 4 is packaged, a packaging volume is small and the packaging is convenient. Moreover, the assembly and the disassembly are more convenient.

Optionally, the bed frame includes a plurality of elastic pins 8 each arranged on a respective one of the first longitudinal bar 41, the second longitudinal bar 42 and the lateral bar 5. That is, one of the plurality of elastic pins 8 is arranged on the first longitudinal bar 41, another one of the plurality of elastic pins 8 is arranged on the second longitudinal bar 42, and yet another one of the plurality of elastic pins 8 is arranged on the lateral bar 5. Each of the plurality of elastic pins 8 is arranged on a respective one of an end of the first longitudinal bar 41, an end of the second longitudinal bar 42, and an end of the lateral bar 5. Each of the plurality of elastic pins 8 is snapped into a respective one of a pin hole 6 of the first longitudinal mounting hole 11, a pin hole 6 of the second longitudinal mounting hole 12, and a pin hole 6 of the lateral mounting hole 21. That is, the elastic pin 8 arranged on the first longitudinal bar 41 is snapped into the pin hole 6 of the first longitudinal mounting hole 11, the elastic pin 8 arranged on the second longitudinal bar 42 is snapped into the pin hole 6 of the second longitudinal mounting hole 12, and the elastic pin 8 arranged on the lateral bar 5 is snapped into the pin hole 6 of the lateral mounting hole 21. Specifically, each of the plurality of elastic pins 8 includes an elastic sheet 81 arranged in the respective one of the first longitudinal bar 41, the second longitudinal bar 42 and the lateral bar 5, and a pin pillar 82 extending beyond the respective one of the first longitudinal bar 41, the second longitudinal bar 42 and the lateral bar 5. The pin pillar 82 is arranged on the elastic sheet 81.

Optionally, each of a side wall of the first longitudinal mounting hole 11, a side wall of the second longitudinal mounting hole 12, and a side wall of the lateral mounting hole 21 is provided with a pin hole 6. Each of the pin hole 6 of the first longitudinal mounting hole 11, the pin hole 6 of the second longitudinal mounting hole 12, and the pin hole 6 of the lateral mounting hole 21 is configured to be connected to a respective one of the elastic pin 8 arranged on the first longitudinal bar 41, the elastic pin 8 arranged on the second longitudinal bar 42, and the elastic pin 8 arranged on the lateral bar 5, to allow the assembly and disassembly of the first longitudinal bar 41, the second longitudinal bar 42 and the lateral bar 5 to be convenient.

The first longitudinal mounting hole 11 and the second longitudinal mounting hole 12 are in communication with each other, to allow the injection molding of the first longitudinal mounting hole 11 and the second longitudinal mounting hole 12 to be more convenient. Certainly, the first longitudinal mounting hole 11 and the second longitudinal mounting hole 12 may also be arranged to be independent of each other.

The longitudinal connecting portion 1, the lateral connecting portion 2 and the supporting portion 3 are integrally formed. Specifically, each of the longitudinal connecting portion 1, the lateral connecting portion 2 and the supporting portion 3 is a plastic member, and the longitudinal connecting portion 1, the lateral connecting portion 2 and the supporting portion 3 are integrally injection-molded.

Optionally, the longitudinal connecting portion 1 is provided with a blocking sheet 7 in an extension of the longitudinal connecting portion 1, and the blocking sheet 7 is arranged opposite to the supporting portion 3. Specifically, the blocking sheet 7 is integrally injection-molded with the longitudinal connecting portion 1, and the blocking sheet 7 is arranged on an edge of the longitudinal connecting portion 1. The blocking sheet 7 is configured to prevent a mechanism arranged on the bed frame, such as a mattress, from being displaced, to enable one component to have a plurality of functions.

In the description of the disclosure, it should be understood that the orientation or positional relationship indicated by the terms “center”, “longitudinal”, “lateral”, “length”, “width”, “thickness”, “upper”, “lower”, “front”, “back”, “left”, “right”, “vertical”, “horizontal”, “top”, “bottom”, “inner”, “outer”, “clockwise”, “counterclockwise” or the like is based on an orientation or positional relationship shown in the drawings. These terms are intended solely for ease of describing the disclosure and simplifying the description, and are not intended to indicate or imply that the devices or elements must have a particular orientation, be constructed and operated in a particular orientation. In this way, these orientation terms are not to be understood as limiting the disclosure.

Furthermore, the terms “first” and “second” are only for purposes of description, and are not to be understood as indicating or implying relative importance or implicitly indicating the number of technical features indicated. Thus, the features defined as “first” and “second” may explicitly or implicitly include one or more of the features. In the description of the disclosure, the meaning of “a plurality of” is two or more, unless expressly defined and specified otherwise.

In the disclosure, unless expressly defined and specified otherwise, the terms “mounted”, “connected”, “connection”, “fixed” or the like should be understood in a broad sense. For example, “connection” may be a fixed connection, a detachable connection, or an integral connection, “connection” may be a mechanical connection or an electrical connection, and “connection” may be a direct connection, an indirect connection through an intermediary, or internal communication of two elements or interaction of two elements. The specific meanings of the above terms in the disclosure may be understood according to the specific situations for those skilled in the art.

In the disclosure, unless expressly defined and specified otherwise, the expression that a first feature is “above” or “below” a second feature may include the fact that the first feature is in direct contact with the second feature, or may include the fact that the first feature is in no direct contact with the second feature, but is in contact with the second feature by another feature between the first feature and the second feature. In addition, the expression that the first feature is “on”, “above” and “over” the second feature includes the fact that the first feature is directly above and diagonally above the second feature, or only indicates the fact that the first feature is horizontally higher than the second feature. The expression that the first feature is “under”, “below” and “beneath” the second feature includes the fact that the first feature is directly below and diagonally below the second feature, or only indicates the fact that the first feature is horizontally lower than the second feature.

In the description of the disclosure, the description of the terms “one embodiment”, “some embodiments”, “examples”, “specific examples”, “some examples” or the like means that specific features, structures, materials, or characteristics described in combination with the embodiment or example are included in at least one embodiment or example of the disclosure. In the description, the schematic expressions of the above terms should not be understood as necessarily referring to the same embodiments or examples. In addition, the specific features, the structures, the materials, or the characteristics described may be combined in any one or more embodiments or examples in a suitable manner. Furthermore, different embodiments or examples described in the description may be integrated and combined by those skilled in the art.

Although the embodiments of the disclosure are shown and described above, it can be understood that the embodiments described above are exemplary and cannot be understood as limiting the disclosure. Those skilled in the art may make changes, modifications, substitutions and variations to the embodiments described above within the scope of the disclosure.

1. A connecting member for a bed frame, comprising a longitudinal connecting portion, a lateral connecting portion and a supporting portion, wherein the longitudinal connecting portion is arranged at an end of the supporting portion, the longitudinal connecting portion is provided with a first longitudinal mounting hole in which a first longitudinal bar is to be assembled, and a second longitudinal mounting hole in which a second longitudinal bar is to be assembled, and the first longitudinal mounting hole is coaxial with the second longitudinal mounting hole and arranged opposite to the second longitudinal mounting hole, wherein the lateral connecting portion intersects with the longitudinal connecting portion, and the lateral connecting portion is provided with a lateral mounting hole in which a lateral bar is to be assembled.

2. The connecting member for the bed frame according to claim 1, wherein each of a side wall of the first longitudinal mounting hole, a side wall of the second longitudinal mounting hole, and a side wall of the lateral mounting hole is provided with a pin hole.

3. The connecting member for the bed frame according to claim 1, wherein the first longitudinal mounting hole and the second longitudinal mounting hole are in communication with each other.

4. The connecting member for the bed frame according to claim 1, wherein the longitudinal connecting portion, the lateral connecting portion and the supporting portion are integrally formed.

5. The connecting member for the bed frame according to claim 4, wherein each of the longitudinal connecting portion, the lateral connecting portion and the supporting portion is a plastic member, and the longitudinal connecting portion, the lateral connecting portion and the supporting portion are integrally injection-molded. longitudinal connecting portion is provided with a blocking sheet in an extension of the longitudinal connecting portion, and the blocking sheet is arranged opposite to the supporting portion.

7. The connecting member for the bed frame according to claim 6, wherein the blocking sheet is integrally injection-molded with the longitudinal connecting portion.

8. A bed frame, comprising a connecting member for the bed frame, a lateral bar and a longitudinal bar, wherein the connecting member for the bed frame comprises a longitudinal connecting portion, a lateral connecting portion and a supporting portion, wherein the longitudinal connecting portion is arranged at an end of the supporting portion, the longitudinal connecting portion is provided with a first longitudinal mounting hole in which a first longitudinal bar is to be assembled, and a second longitudinal mounting hole in which a second longitudinal bar is to be assembled, and the first longitudinal mounting hole is coaxial with the second longitudinal mounting hole and arranged opposite to the second longitudinal mounting hole, wherein the lateral connecting portion intersects with the longitudinal connecting portion, and the lateral connecting portion is provided with a lateral mounting hole in which a lateral bar is to be assembled, wherein the longitudinal bar comprises a first longitudinal bar and a second longitudinal bar, the first longitudinal bar is snapped into the first longitudinal mounting hole, the second longitudinal bar is snapped into the second longitudinal mounting hole, and the lateral bar is snapped into the lateral mounting hole.

9. The bed frame according to claim 8, wherein the bed frame comprises a plurality of elastic pins each arranged on a respective one of the first longitudinal bar, the second longitudinal bar and the lateral bar; each of a side wall of the first longitudinal mounting hole, a side wall of the second longitudinal mounting hole, and a side wall of the lateral mounting hole is provided with a pin hole; each of the plurality of elastic pins is snapped into a respective one of the pin hole of the first longitudinal mounting hole, a-the pin hole of the second longitudinal mounting hole, and the pin hole of the lateral mounting hole.

10. The bed frame according to claim 9, wherein each of the plurality of elastic pins comprises an elastic sheet arranged in the respective one of the first longitudinal bar, the second longitudinal bar and the lateral bar, and a pin pillar extending beyond the respective one of the first longitudinal bar, the second longitudinal bar and the lateral bar, and the pin pillar is arranged on the elastic sheet.

11. The bed frame according to claim 8, wherein each of a side wall of the first longitudinal mounting hole, a side wall of the second longitudinal mounting hole, and a side wall of the lateral mounting hole is provided with a pin hole.

12. The bed frame according to claim 8, wherein the first longitudinal mounting hole and the second longitudinal mounting hole are in communication with each other.

13. The bed frame according to claim 8, wherein the longitudinal connecting portion, the lateral connecting portion and the supporting portion are integrally formed.

14. The bed frame according to claim 13, wherein each of the longitudinal connecting portion, the lateral connecting portion and the supporting portion is a plastic member, and the longitudinal connecting portion, the lateral connecting portion and the supporting portion are integrally injection-molded.

15. The bed frame according to claim 8, wherein the longitudinal connecting portion is provided with a blocking sheet in an extension of the longitudinal connecting portion, and the blocking sheet is arranged opposite to the supporting portion.

16. The bed frame according to claim 15, wherein the blocking sheet is integrally injection-molded with the longitudinal connecting portion.
